(19) United States
(12) Patent Application Publication
(10) Pub. No.: US 2026/0298226 A1
(43) Pub. Date: Oct. 1, 2026

(54) MOTOR AND PUMP COMPRISING SAME

(71) Applicant: LG INNOTEK CO., LTD., Seoul (KR)

(72) Inventor: Sang Tae KIM, Seoul (KR)

(21) Appl. No.: 18/992,374

(22) PCT Filed: Jun. 29, 2023
(86) PCT No.: PCT/KR2023/009177

§ 371 Date: Jan. 8, 2025

(30) Foreign Application Priority Data
Aug. 3, 2022 (KR) 10-2022-0097008

(51) Int. Cl. F04C 2/08; H02K 7/116; H02K 21/16

(52) U.S. Cl. CPC F04C 2/084; F04C 2240/40

(57) ABSTRACT

A motor comprises: a housing; a stator disposed inside the housing; and a rotor disposed inside the stator. The rotor comprises: a rotor core including a body portion, a flange portion extending radially from the bottom of the body portion, and a protrusion portion protruding from an upper surface of the flange portion; and a magnet disposed on the outer surface of the body portion, wherein the protrusion portion is disposed between the flange portion and the magnet.

### TECHNICAL FIELD

The present embodiment relates to a motor and a pump comprising same.

### BACKGROUND ART

The pump includes a motor section that generates rotational driving force and a pump section that generates hydraulic pressure. Therefore, since the motor section and pump section inside the pump are separated from each other, there is a problem of increasing the number of parts and the overall size of the product.

In general, an EOP may include a housing, a stator being disposed inside the housing, and an outer gear and an inner gear being disposed inside the stator. Among these, the arrangement area of the outer gear is set by a can being disposed between the stator, and the arrangement area of the inner gear is set by a cover being coupled with the housing.

Since the EOP according to the prior art does not have a means to support the load applied to the outer gear, there is a problem that the rotational stability of the outer gear or inner gear is deteriorated due to the force being applied at the outlet of the pump as the operating pressure inside the pump increases. In particular, as the driving torque of the outer gear increases when high pressure occurs inside the pump, irregular friction occurs due to rotation, which becomes a factor that degrades the performance of the pump.

### DETAILED DESCRIPTION OF THE INVENTION

### Technical Subject

The present embodiment is intended to provide a motor and a pump including the same that can secure rotational stability of a rotor, thereby minimizing torque loss due to friction, and enhancing the performance of the pump.

### Technical Solution

A motor according to the present embodiment comprises: a housing; a stator being disposed inside the housing; and a rotor being disposed inside the stator, wherein the rotor comprises: a rotor core including a body portion, a rotor core including a flange portion extending radially from a lower end of the body portion and a protrusion portion protruded from an upper surface of the flange portion; and a magnet being disposed on an outer surface of the body portion, and wherein the protrusion portion is disposed between the flange portion and the magnet.

With respect to the axial direction, the flange portion and the magnet can be spaced apart from each other.

With respect to the axial direction, the length of the flange portion may be within 15% to 40% of the length of the body portion.

The protrusion portion can come into contact with the magnet.

With respect to the radial direction, the rotor and the stator can be spaced apart by 0.08 mm to 0.16 mm.

The upper surface of the magnet can be exposed upwardly from the body portion.

It may include a guide portion being protruded from an outer surface of the body portion and facing a side surface of the magnet.

The guide portion may have a pentagonal cross-sectional shape.

The guide portion may include a first side surface being in contact with a side surface of the magnet, a second side surface being disposed on an outer side of the first side surface and spaced apart from a side surface of the magnet, and an outer surface being disposed on an outer side of the second side surface.

A pump according to the present embodiment comprises: a housing; a stator being disposed inside the housing; an outer gear being disposed inside the stator; and an inner gear being disposed inside the outer gear, wherein the outer gear comprises: a body portion; a core including a flange portion extended radially from a lower end of the body portion and a protrusion portion protruded from an upper surface of the flange portion; and a magnet being disposed on an outer surface of the body portion, and wherein the protrusion portion is disposed between the flange portion and the magnet.

### Advantageous Effects

Through the present embodiment, there is an advantage in that a section having the effect of a dynamic pressure bearing inside the rotor is formed through a flange portion, thereby ensuring rotational stability of the rotor.

In addition, due to the magnet floating structure through the protrusion portion, the magnetic force of the magnet can be easily guided to the stator, so there is an advantage of enhancing the performance of the motor and pump.

### BRIEF DESCRIPTION OF DRAWINGS

FIG. 1 is a perspective view illustrating the appearance of a pump according to an embodiment of the present invention.

FIG. 2 is an exploded perspective view of a pump according to an embodiment of the present invention.

FIG. 3 is an exploded perspective view of an outer gear, an inner gear, and a cover according to an embodiment of the present invention.

FIG. 4 is a cross-sectional view of a pump according to an embodiment of the present invention.

FIG. 5 is a perspective view of a rotor according to an embodiment of the present invention.

FIG. 6 is an exploded perspective view of a rotor according to an embodiment of the present invention.

FIG. 7 is a cross-sectional view of a rotor according to an embodiment of the present invention.

### BEST MODE

Hereinafter, preferred embodiments of the present invention will be described in detail with respect to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention. In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used.

These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction based on one component may be included.

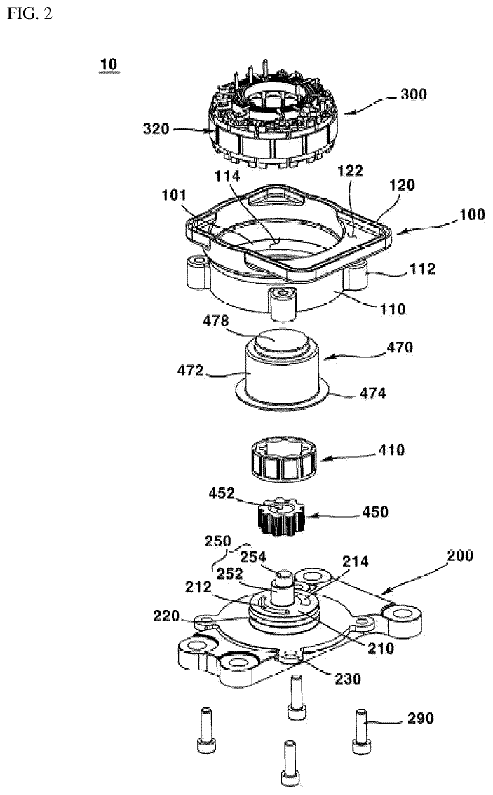

The ‘axial direction’ used hereinafter is defined as the direction forming the center of rotation of the rotor, the inner gear, and the outer gear. The ‘axial direction’ may be the direction in which the components disassembled with respect to FIG. 2 are coupled. The ‘axial direction’ may be defined as the up-down direction.

The ‘radial direction’ used hereinafter is defined as a direction perpendicular to the ‘axial direction’ described above. The ‘radial direction’ can be defined as the protrusion direction of the first lobe from the inner surface of the outer gear, and the protrusion direction of the second lobe from the inner surface of the inner gear.

The ‘circumferential direction’ used hereinafter may be defined as the circumferential direction of any one among the stator, the rotor, the external gear, and the internal gear, or the circumferential direction of an area forming an imaginary concentric circle with the circumferential direction of any one among the stator, the rotor, the external gear, and the internal gear.

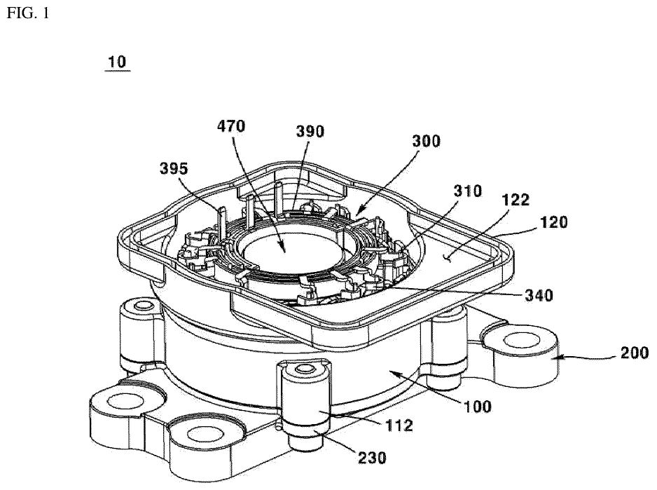

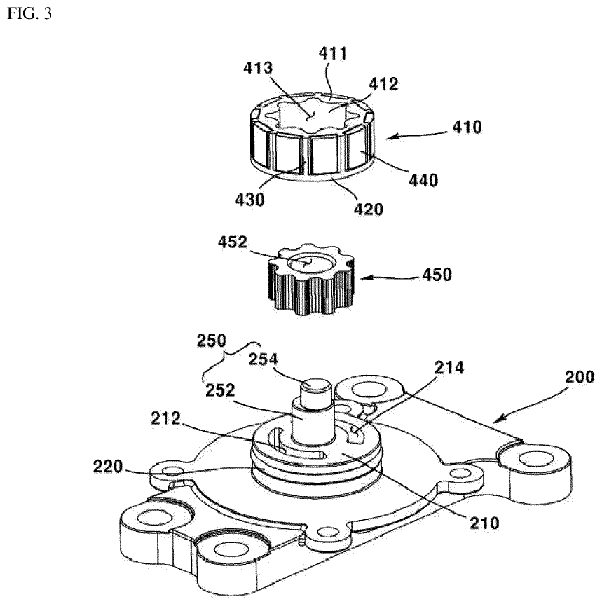

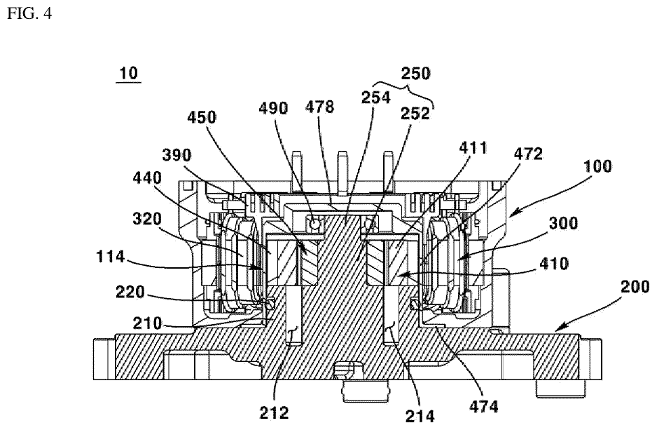

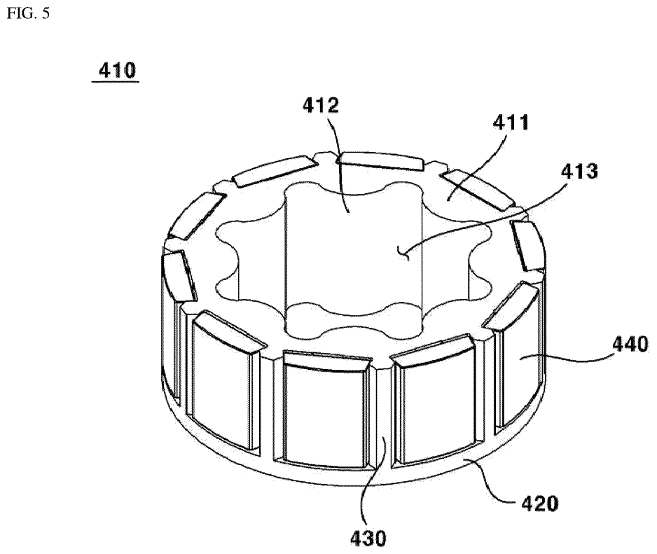

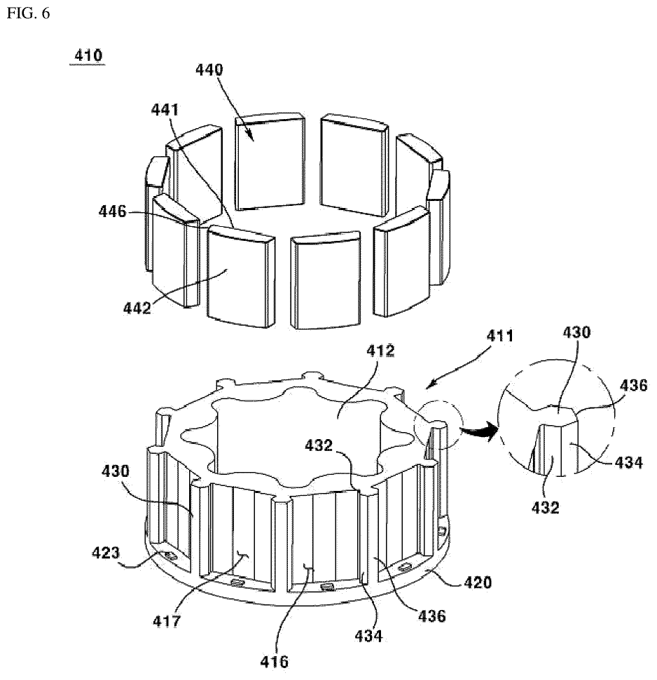

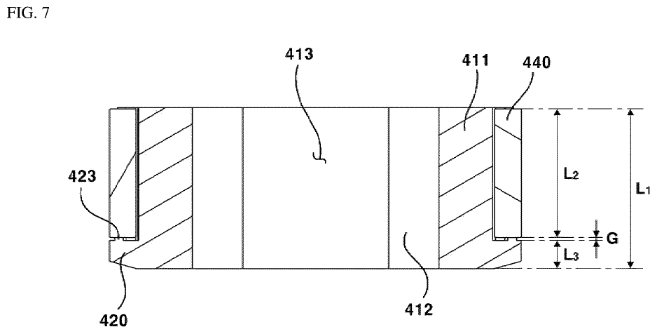

FIG. 1 is a perspective view illustrating the appearance of a pump according to an embodiment of the present invention; FIG. 2 is an exploded perspective view of a pump according to an embodiment of the present invention; FIG. 3 is an exploded perspective view of an outer gear, an inner gear, and a cover according to an embodiment of the present invention; FIG. 4 is a cross-sectional view of a pump according to an embodiment of the present invention; FIG. 5 is a perspective view of a rotor according to an embodiment of the present invention; FIG. 6 is an exploded perspective view of a rotor according to an embodiment of the present invention; and FIG. 7 is a cross-sectional view of a rotor according to an embodiment of the present invention.

Referring to FIGS. 1 to 7, an outer shape of the pump 10 according to an embodiment of the present invention may be formed by the coupling of a housing 100 and a cover 200. The cover 200 may be coupled with a lower surface of the housing 100. The housing 100 and the cover 200 may be screw-coupled through a screw 290. Each of the housing 100 and the cover 200 may include a first coupling portion 112 and a second coupling portion 230 being coupled with the screw 290. The first coupling portion 112 and the second coupling portion 230 may be disposed to face each other in an up and down direction, and may each include a hole being coupled with the screw 290.

The cover 200 may include an opening. In detail, a first opening through which fluid is sucked in and a second opening through which circulated fluid is discharged may be formed on one surface of the cover 200. A third opening 212 connected to the first opening and a fourth opening 214 connected to the second opening may be formed on the other surface of the cover 200. The first opening and the second opening may be formed on a lower surface of the cover 200, and the third opening 212 and the fourth opening 214 may be formed on an upper surface of the cover 200 being coupled with the housing 100.

On an upper surface of the cover 200, a mounting portion 210 being protruded upward and coupled to a space inside the can 470 to be described later may be disposed. Accordingly, the cover 200 may be understood to include a cover body and a mounting portion 210 being protruded from an upper surface of the cover body. The cross-section of the mounting portion 210 may be circular.

The mounting portion 210 may be coupled to a space inside the can 470. The cross-sectional shape of the mounting portion 210 may correspond to the cross-sectional shape of the space inside the can 470. A ring-shaped sealing member 220 for sealing may be disposed between an outer surface of the mounting portion 210 and an inner surface of the space inside the can 470. The sealing member 220 may be formed of a rubber material to prevent fluid from leaking between the outer surface of the mounting portion 210 and the inner surface of the space inside the can 470. A groove may be formed on an outer surface of the mounting portion 210 being recessed more than other areas and into which the sealing member 220 is coupled.

A third opening 212 through which fluid is sucked in and a fourth opening 214 through which the sucked fluid is discharged may be formed on an upper surface of the cover 200. The fluid may be oil. Each of the third opening 212 and the fourth opening 214 may be formed to have an arc shape, and may be disposed so that the gap between them gradually narrows as it travels from one side to the other. More specifically, the side where the gap between the third opening 212 is wide may be disposed so that it faces the side where the gap between the fourth opening 214 is wide, and the side where the gap between the third opening 212 is narrow may be disposed so that it faces the side where the gap between the fourth opening 214 is narrow.

The third opening 212 and the fourth opening 214 can be formed on an upper surface of the mounting portion 210.

The housing 100 may be formed of metal or plastic material, but is not limited thereto.

The above pump 10 may include a motor. The motor may include a housing 100, a stator 300, and a rotor 410. The rotor 410 is a component inside the pump 10 and may also be referred to as an outer gear 410.

The housing 100 may include an upper region 120 and a lower region 110. The upper region 120 may have a rectangular cross-section. The lower region 110 is disposed at a lower portion of the upper region 120 and may be formed to have a circular cross-section.

A second space 122 may be formed inside the upper region 120. The second space 122 may have a groove shape. A plurality of electronic components for driving may be disposed in the second space 122. For example, a printed circuit board not shown and a terminal 395 may be disposed in the second space 122. A plurality of elements may be mounted on the printed circuit board.

The housing 100 may include a first partition wall 101 (see FIG. 2) dividing the upper region 120 and the lower region 110. A hole may be formed in the center of the first partition wall 101 to which a first protruded portion 478 of a can 470 to be described later is coupled.

A separate cover not shown may be coupled on an upper surface of the housing 100 to cover the second space 122. In this case, the separate cover is referred to as a second cover, and the cover 200 may be referred to as a first cover 200.

A stator 300 and a rotor 410 may be disposed in the housing 100. The rotor 410 may be disposed on the cover 200.

The stator 300 can be disposed inside the housing 100.

When the material of the housing 100 is plastic, the stator 300 can be formed integrally with the housing 100 by double injection. The stator 300 and the housing 100 can be formed integrally by insert injection. The stator 300 can be molded inside the housing 100. A stator accommodating space in which the stator 300 is disposed can be formed inside the housing 100. The stator receiving space can be disposed outside the first space 114. The outer surface of the stator 300 can be surrounded by the housing 100.

The stator 300 may include a stator core 320 and a coil 310 being wound around the stator core 320. The stator 300 may include an insulator not shown disposed to surround an outer surface of the core. The coil 310 may be wound around an outer surface of the insulator.

A router 390 may be disposed on an upper surface of the stator core 320, and the coil 310 being protruded upward from the stator core 320 may be aligned by the router 390.

A bus bar 340 may be disposed on an upper surface of the router 390, and an end portion of the coil 310 being protruded upward from the stator core 320 may be fused to the bus bar 340.

A terminal 395 may be disposed on an upper surface of the router 390, and the terminal 395 may have a shape being protruded upward from the router 390. The printed circuit board may be electrically connected to the terminal 395.

The first space 114 may be formed in the center of the housing 100. The first space 114 may be formed at an inner side of the lower region 110. The first space 114 may have a groove shape in which a portion of a lower surface of the housing 100 is upwardly recessed. The arrangement area of the stator 300 and the first space 114 may be partitioned by a second partition wall (not shown). The inner surface of the second partition wall may form an inner surface of the first space 114. In other words, the second partition wall may be disposed between the stator 300 and an outer gear 410 to be described later. The second partition wall may be formed to have a thickness of 0.2 mm to 1 mm.

The second space 122 and the first space 114 can be partitioned in an upper direction and a lower direction by the first partition wall 101. The lower surface of the first partition wall 101 can form an upper surface of the first space 114. The first space 114 and the second space 122 can be partitioned into different regions through the first partition wall 101. Accordingly, the fluid inside the first space 114 can be prevented from flowing into the second space 122.

The rotor 410 may be disposed inside the stator 300. As described above, the rotor 410 may be referred to as an outer gear 410 as a component of a motor or a component of a pump 10. As a component of the pump 10, the gear may include an outer gear 410 and an inner gear 450. The outer gear 410 and the inner gear 450 may be disposed in the first space 114.

The rotor 410 may be disposed inside the stator 300. The second partition wall may be disposed between the rotor 410 and the stator 300. The rotor 410 includes a magnet 440, and when a current is applied to the coil 310 of the stator 300, the rotor 410 may rotate by electromagnetic interaction between the stator 300 and the rotor 410.

A first hole 413 may be formed in the center of the rotor 410 in which the inner gear 450 is disposed. A plurality of peaks 412 being protruded inwardly from an inner surface and a plurality of grooves being disposed between the plurality of peaks 412 may be formed on an inner surface of the first hole 413 (see FIG. 5). That is, a first gear may be formed in which a plurality of peaks and grooves are disposed alternately on an inner circumferential surface of the first hole 413.

The inner gear 450 may be disposed inside the rotor 410. The inner gear 450 may be disposed in the first hole 413. The rotor 410 may be referred to as an outer rotor, and the inner gear 450 may be referred to as an inner rotor.

In an outer circumferential surface of the inner gear 450 may include a plurality of peaks 454 being protruded outwardly from the outer surface, and grooves being disposed between the pluralities of peaks 454. A second gear may be formed on an outer surface of the inner gear 450 in which a plurality of peaks 454 and a plurality of grooves are disposed alternately.

In other words, the inner gear 450 may have a second lobe having N gear teeth radially outwardly disposed along a circumferential direction based on the center of rotation. The rotor 410 may have N+1 first lobes radially and inwardly disposed. The first lobe may be disposed to be caught by the second lobe. When the rotor 410 rotates, the inner gear 450 may be rotated by the first lobe and the second lobe. Depending on the rotation of the inner gear 450, a fluid may be introduced into a space inside a can 470 to be described later, or a fluid inside the space inside the can 470 may be discharged to the outside.

The rotor 410 and the inner gear 450 can rotate eccentrically. Due to the eccentricity of the rotor 410 and the inner gear 450, a volume capable of transporting fluid fuel is generated between the rotor 410 and the inner gear 450, and the part where the volume increases sucks in the surrounding fluid due to a decrease in pressure, and the part where the volume decreases discharges the fluid due to an increase in pressure.

The inner gear 450 and the rotor 410 may be disposed so that their centers do not coincide with each other. The centers of rotation of the rotor 410 and the inner gear 450 may be different.

A hole 452 into which a shaft 250 to be described later is coupled can be formed in the center of the inner gear 450.

The pump 10 may include a can 470. The can 470 may be disposed in the first space 114. The can 470 may be formed of a metal material. The can 470 may be formed integrally with the housing 100 by double injection. However, this is exemplary, and the can 470 may also be formed of a plastic material.

The above can 470 may include a body portion 472, a lower end portion 474 being protruded outward from a lower end of the body portion 472, and a first protruded portion 478 being protruded upward from an upper surface of the body portion 472.

A space may be formed inside the body portion 472. The inner gear 450 and the rotor 410 may be disposed in the space. The cross-sectional shape of the body portion 472 may be formed to correspond to the cross-sectional shape of the first space 114. For example, the cross-sectional shape of the body portion 472 may be circular.

The lower end portion 474 may be formed to be extended outwardly by being bent from the lower end of the body portion 472. The lower end portion 474 may be disposed between the lower surface of the housing 100 and the upper surface of the cover 200.

The first protruded portion 478 can be coupled to a hole in the first partition wall 101. The cross-sectional shape of the first protruded portion 478 can be formed to correspond to the cross-sectional shape of the hole. The upper end of the first protrusion 478 can be protruded upward from an upper surface of the first partition wall 101.

A bearing space for accommodating a bearing 490 to be described later may be formed inside the first protruded portion 478. The first protruded portion 478 may be formed to have a smaller cross-sectional area than the body portion 472.

The fluid in the first space 114 can be prevented from flowing into the second space 122 by the can 470.

The motor may include a bearing 436. The bearing 490 may be disposed on the rotor 410. The bearing 490 may be a ball bearing. Accordingly, the bearing 490 may include a ball being disposed between an outer ring and an inner ring. A hole may be formed in the center of the bearing 490. A shaft 250 may be coupled to the hole. The shaft 250 may be press-fitted into the hole. The shaft 250 may be coupled to the inner ring. An outer surface of the shaft 250 may be in contact with an inner surface of the inner ring. Therefore, when the rotor 410 rotates, the bearing 490 may support the rotation of the rotor 410. In some cases, the motor may include a support (not shown) being rotatably coupled with the rotor 410 and rotates the bearing 490 together with the rotation. In this case, the bearing 490 may be rotated against the shaft 250 by the rotation of the rotor 410.

The pump 10 may include a shaft 250. The shaft 250 may support the rotation of the inner gear 450 or the rotor 410. The shaft 250 may have a shape being protruded upward from an upper surface of the cover 200. The shaft 250 may have a shape being protruded upward from an upper surface of the mounting portion 210. The shaft 250 may be formed as one body with the cover 200.

The shaft 250 may include a first region 252 being coupled to the inner gear 450 and a second region 254 being coupled to the bearing 490. The first region 252 may be coupled to a hole 452 of the inner gear 450, and the second region 254 may be coupled to a hole of the bearing 490.

Each of the first region 252 and the second region 254 may have a circular cross-section. The first region 252 and the second region 254 may have different centers. The center O1 of the first region 252 may be different from the center O2 of the second region 254. The first region 252 and the second region 254 may be disposed eccentrically.

The center of the first region 252 may correspond to the center of rotation of the inner gear 450. The center of the second region 254 may correspond to the center of rotation of the rotor 410. Accordingly, the rotation of the bearing 490 and the rotor 410 may be supported with the second region 254 as the center, and the rotation of the inner gear 450 may be supported with the first region 252 as the center.

Hereinafter, the rotor 410 will be described.

The rotor 410 may be disposed inside the stator 300. The rotor 410 may be spaced apart from the inner surface of the can 470 by 0.08 mm to 0.16 mm with respect to the radial direction. When the can 470 is omitted, the rotor 410 may be spaced apart from the stator 300 by 0.08 mm to 0.16 mm with respect to the radial direction.

As illustrated in FIGS. 5 to 7, the rotor 410 may include a rotor core including a body portion 411, a flange portion 420, a protrusion portion 423, and a guide portion 436. In addition, the rotor 410 may include a magnet 440 being disposed on an outer surface of the body portion 411. The body portion 411, the flange portion 420, the guide portion 436, and the protrusion portion 423 may be formed of a metal material and formed integrally. The body portion 411, the flange portion 420, the guide portion 436, and the protrusion portion 423 may be formed as one body. Unlike this, the material of the body portion 411, the flange portion 420, and the protrusion portion 423 may be plastic.

The rotor core may be referred to as a core.

The body portion 411 can form the outer shape of the rotor 410. The body portion 411 can be formed in a ring shape with the upper and lower surfaces open. A first hole 413 can be formed in the center of the body portion 411 being extended in an axial direction and coupled with the inner gear 450. As described above, a plurality of ridge sections 412 and valley sections can be disposed along a circumferential direction alternately on an inner circumferential surface of the first hole 413.

A first groove 416 to which the magnet 440 is coupled may be formed on an outer circumferential surface of the body portion 411. The first groove 416 may have a shape being recessed inward from an outer surface of the body portion 411 compared to other regions. The first grooves 416 may be provided in plurality and may be disposed to be spaced apart from each other along the circumferential direction of the body portion 411. The magnet 440 may be coupled to the first groove 416.

A second groove 417 may be formed on a bottom surface of the first groove 416 so as to be recessed more inwardly than other regions. An adhesive may be applied to the second groove 417. Through the adhesive being applied to the second groove 417, the inner surface of the magnet 440 may be coupled to a bottom surface of the first groove 416. Meanwhile, the adhesive may also be applied to a bottom surface of the first groove 416.

A guide portion 430 may be disposed between the pluralities of first grooves 416. The guide portion 430 may have a shape being protruded outward from an outer surface of the body portion 411. The guide portion 430 may be disposed between two adjacent magnets 440. When the magnet 440 is coupled to the body portion 411, the inner surface 444 of the magnet 440 may be disposed to face the bottom surface of the first groove 416 in a radial direction, and the side surface of the magnet 440 may be disposed to face the side surface of the guide portion 430 in a circumferential direction.

The above guide portion 430 may have a polygonal cross-sectional shape. For example, the cross-sectional shape of the guide portion 430 may be a pentagon. The guide portion 430 may include the first side surface 432, the second side surface 434, and the outer surface 436.

With respect to a single guide portion 430, the first side surface 432 may be provided in plurality and disposed to face each other. The first side surface 432 may form an acute angle with the outer surface of the body portion 411. The first side surface 432 may be in contact with the side surface 446 of the magnet 440. The first side surface 432 may form the inner surface of the first groove 416. With respect to the radial direction of the body portion 411, the first side surface 432 may be an inclined surface having a shape in which the circumferential length of the first groove 416 becomes smaller as it goes outward. With respect to the radial direction of the body portion 411, the first side surface 432 may be an inclined surface having a shape in which the circumferential length to the first side surface 432 of the adjacent guide portion 430 becomes smaller as it goes outward.

With respect to a single guide portion 430, the second side surface 434 may be provided in multiple numbers and disposed to face each other. The second side surface 434 may be disposed on an outer side of the first side surface 432. The second side surface 434 may be spaced apart from the side surface 446 of the magnet 440. The second side surface 434 may form the inner surface of the first groove 416. With respect to the radial direction of the body portion 411, the second side surface 434 may be an inclined surface having a shape in which the circumferential length of the first groove 416 increases as it goes outward.

The outer surface 436 of the guide portion 430 may be disposed to connect the plurality of second side surfaces 434. The outer surface 436 of the guide portion 430 may be a flat surface, but, unlike this, may be a curved surface having a predetermined curvature. When the outer surface 436 of the guide portion 430 is a curved surface, the curvature of the outer surface 436 may correspond to the curvature of the bottom surface of the first groove 416 or may correspond to the curvature of the flange portion 420 to be described later. The outer surface 436 may be disposed to form the same plane as the outer surface of the flange portion 420. The radial length from the center of the body portion 411 to the outer surface 436 of the guide portion 430 may correspond to the radial length from the center of the body portion 411 to the outer surface 442 of the magnet 440. The radial length from the center of the body portion 411 to the outer surface 436 of the guide portion 430 may correspond to the radial length from the center of the body portion 411 to the outer surface of the flange portion 420.

The magnet 440 may be disposed in the first groove 416 being disposed between the pluralities of guide portions 430. The magnets 440 may be provided in plurality and may be disposed spaced apart from each other along a circumferential direction of the body portion 411. The magnet 440 may include an outer surface 442, an inner surface 444, and a side surface 446 connecting the outer surface 442 and the inner surface 444.

The side surface 446 of the magnet 440 may be disposed to face the first side surface 432 of the guide portion 430. The side surface 446 of the magnet 440 may be in contact with the first side surface 432 of the guide portion 430. The side surface 446 of the magnet 440 and the first side surface 432 of the guide portion 430 may be inclined surfaces with shapes corresponding to each other.

The outer surface 442 of the magnet 440 can be spaced apart from the outer surface 436 of the guide portion 430 in a circumferential direction. The inner surface 446 of the magnet 440 can be coupled to a bottom surface of the first groove 416, that is, an outer circumferential surface of the body portion 411.

The rotor 410 may include a flange portion 420. The flange portion 420 may have a shape being protruded radially from one end of the body portion 411. By the flange portion 420, the rotor 410 may include a plurality of regions having different radial lengths with respect to the center. The upper surface of the flange portion 420 may be disposed to face the lower surface of the magnet 440. An upper surface of the flange portion 420 may be spaced apart from a lower surface of the magnet 440. A gap G may be formed between the upper surface of the flange portion 420 and the lower surface of the magnet 440.

As in FIG. 7, the axial length L1 of the body portion 411 may be equal to the sum of the axial length L2 of the magnet 440, the axial length L3 of the flange portion 420, and the axial length of the gap G.

The radial length from the center of the body portion 411 to the outer surface 436 of the guide portion 430 may correspond to the radial length from the center of the body portion 411 to an outer surface of the flange portion 420. The radial length from the center of the body portion 411 to the outer surface 442 of the magnet 440 may correspond to the radial length from the center of the body portion 411 to an outer surface of the flange portion 420. With respect to the axial direction, the length of the flange portion 420 may be shorter than the length of the guide portion 430. With respect to the axial direction, the length of the flange portion 420 may be within 15% to 40% of the length of the rotor 410 or the body portion 411.

The first groove 416 may have an inner surface defined by the side surface of the guide portion 430 and the upper surface of the flange portion 420. The magnet 440 may have both side surfaces 446 and a lower surface covered by the side surface of the guide portion 430 and the upper surface of the flange portion 420, respectively, and the upper surface may be opened upward.

The rotor 410 may include a protrusion portion 423. The protrusion portion 423 may be formed to be protruded from one surface of the flange portion 420 that faces the magnet 440 in an axial direction. The protrusion portion 423 may be disposed to overlap the magnet 440 in an axial direction. The protrusion portion 423 may be formed to be protruded upward from an upper surface of the flange portion 420. Through the protrusion portion 423, a lower surface of the magnet 440 may be spaced apart from an upper surface of the flange portion 420 in an axial direction. An upper surface of the protrusion portion 423 may be in contact with a lower surface of the magnet 440. With respect to a single first groove 416, the protrusion portion 423 can be disposed at the center of the circumference of the flange portion 420. With respect to a single first groove 416, the protrusion portion 423 can be disposed one by one, but unlike this, it can be provided in multiple forms and disposed spaced apart from one another.

With respect to an axial direction, the length of the protrusion portion 423 can be formed to be smaller than the length of the flange portion 420.

The area of the area where the protrusion portion 423 and the magnet 440 come into contact may be smaller than the area of the upper surface of the flange portion 420 facing the magnet 440.

According to the above structure, there is an advantage in that a section having the effect of a dynamic pressure bearing inside a rotor is formed through the flange portion, thereby ensuring rotational stability of the rotor.

In addition, because of the magnet floating structure through the protrusion portion, the magnetic force of the magnet can be easily guided to the stator, so there is an advantage of enhancing the performance of the motor and pump.

Meanwhile, in the present embodiment, the flange portion 420 is disposed at a lower end of the body portion 411 facing the cover 200, but this is not limited thereto, and the flange portion 420 may be disposed at an upper end of the body portion 411 facing the bearing 490. In this case, the protrusion portion 423 may be formed to be protruded downward from the lower surface of the flange portion 420 facing the magnet 440.

In the above description, it is described that all the components constituting the embodiments of the present invention are combined or operated in one, but the present invention is not necessarily limited to these embodiments. In other words, inside the scope of the present invention, all of the components may be selectively operated in combination with one or more. In addition, the terms “comprise”, “include” or “having” described above mean that the corresponding component may be inherent unless specifically stated otherwise, and thus it should be construed that it does not exclude other components, but further include other components instead. All terms, including technical and scientific terms, have the same meaning as commonly understood by one of ordinary skill in the art unless otherwise defined. Terms used generally, such as terms defined in a dictionary, should be interpreted to coincide with the contextual meaning of the related art, and shall not be interpreted in an ideal or excessively formal sense unless explicitly defined in the present invention.

The above description is merely illustrative of the technical idea of the present invention, and those skilled in the art to which the present invention pertains may make various modifications and changes without departing from the essential characteristics of the present invention. Therefore, the embodiments disclosed in the present invention are not intended to limit the technical idea of the present invention but to describe the present invention, and the scope of the technical idea of the present invention is not limited by these embodiments. The protection scope of the present invention should be interpreted by the following claims, and all technical ideas inside the equivalent scope should be interpreted as being included in the scope of the present invention.

1. A motor comprising:
a housing;
a stator disposed inside the housing; and
a rotor disposed inside the stator,
wherein the rotor comprises:
a rotor core including a body portion, a rotor core including a flange portion extending radially from a lower end of the body portion and a protrusion portion protruded from an upper surface of the flange portion; and
a magnet disposed on an outer surface of the body portion, and
wherein the protrusion portion is disposed between the flange portion and the magnet.

2. The motor according to claim 1,
wherein with respect to an axial direction, the flange portion and the magnet are spaced apart from each other.

3. The motor according to claim 1,
wherein with respect to an axial direction, a length of the flange portion is within 15% to 40% of a length of the body portion.

4. The motor according to claim 1,
wherein the protrusion portion is come into contact with the magnet.

5. The motor according to claim 1,
wherein with respect to the radial direction, the rotor and the stator are spaced apart by 0.08 mm to 0.16 mm.

6. The motor according to claim 1,
wherein an upper surface of the magnet is exposed upwardly from the body portion.

7. The motor according to claim 1, including:
a guide portion protruded from an outer surface of the body portion and facing a side surface of the magnet.

8. The motor according to claim 7,
wherein the guide portion has a pentagonal cross-sectional shape.

9. The motor according to claim 7,
wherein the guide portion includes a first side surface in contact with a side surface of the magnet, a second side surface disposed on an outer side of the first side surface and spaced apart from a side surface of the magnet, and an outer surface disposed on an outer side of the second side surface.

10. The motor according to claim 2, wherein a radial length from a center of the body portion to an outer surface of the guide portion is equal to a radial length from the center of the body portion to an outer surface of the flange portion.

11. The motor according to claim 9, wherein a radial length from a center of the body portion to an outer surface of the guide portion is equal to a radial length from the center of the body to an outer surface of the magnet.

12. The motor according to claim 9, wherein based on a radial direction of the body portion, the first side surface is an inclined surface having a shape in which a circumferential length to the first side surface of an adjacent guide portion becomes smaller as it goes outward.

13. The motor according to claim 7, wherein the body portion, the flange portion, the protrusion portion and the guide portion are one body.

14. The motor according to claim 1, wherein an axial length (L1) of the body portion is a sum of an axial length (L2) of the magnet, an axial length (L3) of the flange portion, and the axial length of the gap (G) between the protrusion portion and the magnet.

15. The motor according to claim 7, wherein an outer surface of the guide portion has a same curvature as an outer surface of the flange portion.

16. A pump comprising:
a housing;
a stator being inside the housing;
an outer gear disposed inside the stator; and
an inner gear disposed inside the outer gear,
wherein the outer gear comprises:
a body portion; a core including a flange portion extended radially from a lower end of the body portion and a protrusion portion protruded from an upper surface of the flange portion; and a magnet being disposed on an outer surface of the body portion, and
wherein the protrusion portion is disposed between the flange portion and the magnet.

17. The pump according to claim 16, wherein with respect to an axial direction, the flange portion and the magnet are spaced apart from each other.

18. The pump according to claim 16, wherein with respect to an axial direction, a length of the flange portion is within 15% to 40% of a length of the body portion.

19. The pump according to claim 16, wherein the protrusion portion comes into contact with the magnet.

20. The pump according to claim 16, wherein with respect to the radial direction, the rotor and the stator are spaced apart by 0.08 mm to 0.16 mm.
